(19) United States
(12) Patent Application Publication
(10) Pub. No.: US 2006/0238792 A1
(43) Pub. Date: Oct. 26, 2006

(54) Color rendering for toner-save printing

(75) Inventors: Ching-Wei Chang, Vancouver, WA (US); Jiaping Song, Vancouver, WA (US)

Correspondence Address: ROBERT VARITZ, 4915 SE 33RD PLACE, PORTLAND, OR, 97202, US

(73) Assignee: Sharp Laboratories of America, Inc.

(21) Appl. No.: 11/115,813

(22) Filed: Apr. 26, 2005

(51) Int. Cl. G06F 3/12

(52) U.S. Cl. 358/1.13

(57) ABSTRACT

A pre-printing toner-save method for selective, different-character Page Description Language (PDL) color-object rendering of different-category PDL color objects. This method includes (1) a preliminary determination regarding whether such an object is categorizable as a text object, as a graphics object, or as a raster object, and (2) a subsequent, “post categorization” evaluation of whether the specific-category object nominally selected for toner-save treatment possesses a certain preselected threshold characteristic (or characteristics). Objects so categorized and “successfully thresholded” are then subjected to differentiation into different object regions (edge and non-edge), and then to toner-save rendering which includes the two, collaborative steps of (a) preserving object-edge dot density, and (b), within an object's bounding edge, establishing a checkerboard pattern of dots which maximizes dot gain.

### BACKGROUND AND SUMMARY OF THE INVENTION

This invention pertains to color object (or image) rendering for toner-save printing, and more specifically, to a method for enabling and producing selective, different-character color-object rendering with respect to different-category Page Description Language (PDL) color objects. Hereinafter, the term “image” will be used interchangeably with the term “object”. They will be treated as being synonymous.

Actual implementation of toner-save rendering, in accordance with the invention, is based, from one point of view, upon the specific category of such an object, and within each such category, further upon the presence of a particular object-threshold object characteristic. From another point of view, the invention involves selecting a PDL color object for toner-save rendering, distinguishing edge-boundary regions from other regions in the selected object, and then applying different region-specific toner-save rendering modalities. These two modalities include (a) an edge pixel density preservation modality, and (b) a checkerboarding pixel dot-gain maximizing modality.

In the description of the invention herein, three specific categories of PDL color images are addressed. One of these categories involves a text (font) image, another involves a graphics (vector object) image, and the third involves a raster image (typically rectangular in shape). With respect to a text-category image, font size is employed as a threshold determiner for whether or not toner-save rendering is to be employed. With regard to a graphics-category image, the operative threshold respecting whether or not to utilize toner-save printing involves the existence in the image of a predetermined combination of image pixel width and image pixel height. In the case of a raster-category image, the categorical determination associated with that image, namely, that it is a raster image, also functions as the operative threshold for determining whether or not to employ toner-save printing.

Where a toner-save method of rendering is selected for pre-printing implementation by a user, and where the relevant image, or object, threshold is met, such rendering, in accordance with the practice of the invention, includes two steps. One of these steps involves preserving image-edge dot density, and the other step involves establishing a checkerboard, dot-gain-maximizing pattern of dots to be employed within the edge boundary of an image. A further consideration, and practice, is that toner-save rendering, when selected and implemented, is always practiced in what is known to those skilled in the art as a bi-tonal mode of operation.

Practice of the present invention offers a significant improvement over prior art toner-save methods in relation to preserving rendered image resolution and overall image quality.

The various features and advantages which are offered by the invention, and which make possible the just-stated improvement in color-image (color-object) rendering, will become more fully apparent as the description which now follows is read in conjunction with the accompanying drawings.

### DESCRIPTION OF THE DRAWINGS

FIG. 1 is a high-level, block/schematic diagram illustrating a preferred embodiment and manner of practicing the toner-save, color-image rendering steps of the present invention.

FIG. 2 is a fragmentary block/schematic diagram generally illustrating steps that are involved, in accordance with the practice of the invention, to implement toner-save rendering.

FIG. 3 is a more detailed block/schematic diagram which provides a more specific picture of the structure and methodology shown more generally in FIG. 1.

FIG. 4 presents a visual representation of a color image which has been toner-save rendered in accordance with preferred practice of the present invention.

### DETAILED DESCRIPTION OF THE INVENTION

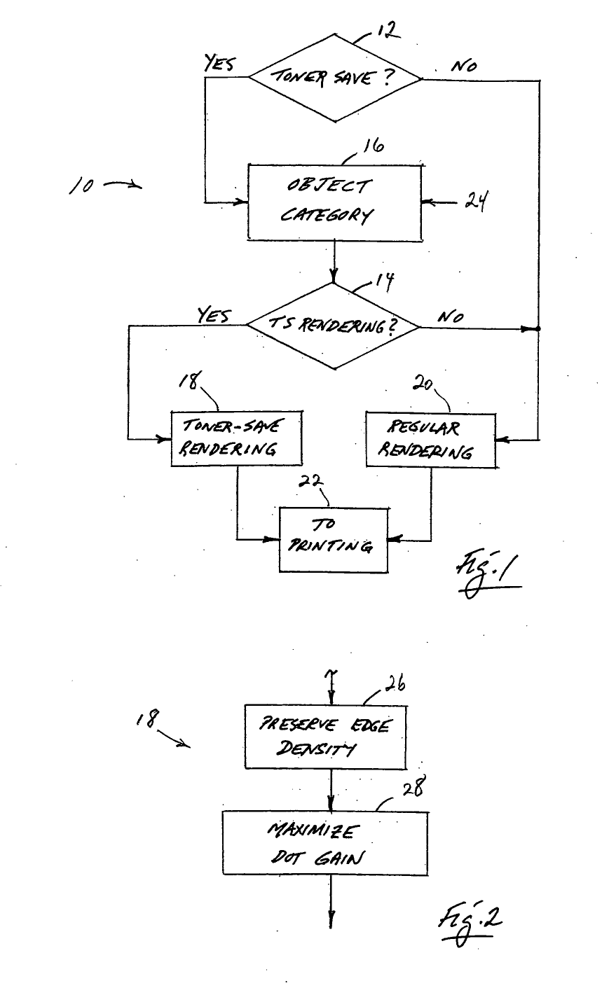

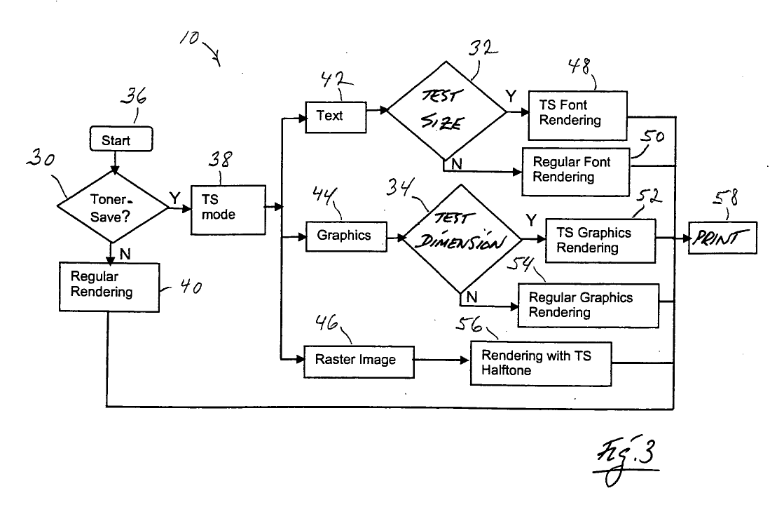

Turning now to the drawings, and beginning with FIGS. 1 and 2, indicated generally at 10 in FIG. 1, in block/schematic form, is an illustration of both the preferred methodology, and the preferred general structural organization, of the system and practice of the present invention. From the description which now follows, when read in conjunction with these and the other two drawing figures, those generally skilled in the relevant art will know clearly how to implement and practice the invention.

Included in system and methodology 10 (reference hereinafter will be made more specifically to methodology), as shown in FIG. 1, are two diamond-shaped blocks 12, 14, and four rectangular blocks 16, 18, 20, 22. Appropriately shown interconnecting these several blocks are arrow-headed lines which generally picture the operational flow that is implemented by methodology 10.

Block 12, marked “TONER-SAVE?”, asks, as on a user-interface display screen, a question of a user preparing to call for printing of a PDL color image (object). This question asks whether that user wishes (Yes/No) to call for toner-save color rendering of an image selected for printing. The (Yes/No) paths out of block 20 are clearly illustrated in FIG. 1, with the “Yes” path leading to block 16, marked “IMAGE CATEGORY”, and the “No” path leading to block 20, marked “REGULAR RENDERING”. Block 12 thus represents an opportunity for a user of the methodology of this invention to make a specific “Yes/No” selection regarding implementation or non-implementation of toner-save color-image rendering.

If a “No” selection is made, whatever the image is is simply treated in block 20 to regular, conventional rendering, and is then passed along from block 20 to block 22 which is labeled “TO PRINTING”.

If the answer posed to the question presented in accordance with block 12 is “Yes”, then control effectively passes to block 16 which obtains information (see arrow 24 in FIG. 1) from the relevant imaging system (not part of this invention) which describes the nature, or category, of PDL image, or object, that has been selected for toner-save rendering. In this context, there are three high-level general categories of imagery (objects) which are specifically addressed by the present invention. These three categories include (a) text imagery, (b) graphics imagery, (c) and raster imagery. Thus, in block 16, after a “Yes” toner-save decision has occurred, the first image-related determination which takes place by operation of the invention is the category of the image respecting which toner-save rendering is to take place. Previously mentioned arrow 24, which points toward the right side of block 16 in FIG. 1, represents the presentation of image-category information from the relevant PDL imaging-system interpreter regarding the specific category of imagery just mentioned.

From block 16, control is handed to block 14, labeled “TS RENDERING?”. This block essentially asks the next question, which is whether or not the categorically specific image that has been identified by block 16, possesses certain predetermined imagery characteristics (a threshold) which make it suitable for tone-save rendering. In other words, because of this thresholding consideration, not necessarily are all images actually subjected to toner-save rendering. Rather, and in order that the system and methodology of this invention will operate most efficiently and effectively, a further image-specific determination is made in order to confirm whether or not toner-save rendering is actually to take place. This thresholding practices separates images with regard to which toner-save rendering is unnecessary and/or inappropriate.

With regard to text imagery, font size is employed as a threshold determiner regarding whether or not a particular text image is to be presented for toner-save rendering. Clearly, and as will be recognized by those generally skilled in the relevant art, what this toner size specifically is is a matter of user/system-designer choice. In the preferred implementation of methodology 10 now being described herein, the font-size threshold level which has been selected is font-size-12.

With regard to graphics imagery, the threshold determiner involves an assessment of both image pixel height and image pixel width. While these two pixel dimensions may be different in number if desired, in most instances it has been found to be preferable to employ like size numbers for both of these dimensions. In the preferred embodiment of the invention now being described, the pixel height and pixel width numbers are the same, and are set at the level of 8-pixels.

With respect to a raster image, that categorical determination alone is employed, without any additional threshold questioning, to determine that such an image is indeed appropriate for toner-save rendering.

A point which should be made here regarding what occurs when the question presented by block 12 is answered in the affirmative is that the related imaging system is placed in a condition for performing any actually implemented toner-save rendering in a bi-tonal mode of operation. Those skilled in the art will immediately recognize the significance of this selection, and also how it may be implemented.

With respect to the operation of block 14, if a particular image which has been reviewed has characteristics that lead to a “Yes” answer emerging from block 14, control passes to block 18, labeled “TONER-SAVE RENDERING”. Block 18 performs toner-save rendering, as will shortly be described, and passes rendered imagery data to block 22 for ultimate printing. If an image being reviewed for toner-save rendering results in a “No” answer emerging from block 14, that image is passed directly to block 20 for regular rendering, after which, such rendered image data is passed to block 22 for printing.

Turning attention now more specifically to FIG. 2, this fragmentary block/schematic diagram presents a somewhat more detailed picture of previously described toner-save rendering block 18 shown in FIG. 1. In accordance with practice of the present invention, toner-save rendering fundamentally involves two steps which are represented in FIG. 2 by two blocks, 26, 28.

The step represented by block 26, labeled “PRESERVE EDGE DENSITY”, involves a decision not to make any change in current pixel edge density (a preserving pixel edge density modality). Thus, for all of the categories of imagery which are to be subjected to toner-save printing, all will be treated in exactly this fashion with respect to the preservation of edge density in the region of an object's edge.

The other step is represented by block 28, labeled “MAXIMIZE DOT GAIN”. This step of the invention relates to pixel content in the region within an image's bounding edge. Fundamentally what is implemented here is the rendering of an image so as to create, within the image's edge, or boundary, a pixel distribution which is checkerboard-like in nature, and which, when implemented appropriately, results in the inside region of an image displaying what is known in the art as maximum pixel dot gain. This concept of maximum pixel dot gain is well known to those skilled in the art, and needs no elaboration here. This rendering practice is referred to herein as a checkerboarding dot-gain maximizing modality.

Completion of the activities represented by blocks 26, 28 in FIG. 2 effects the desired and requested color-image toner-save rendering in accordance with practice of the invention.

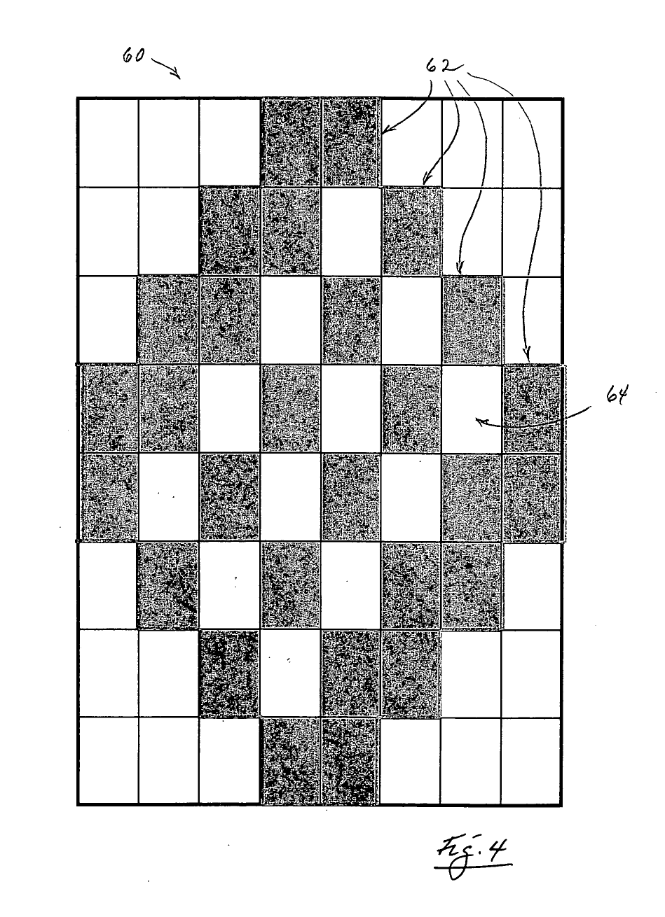

Before turning specific attention to FIG. 4 in the drawings which presents a representative image that has been toner-save rendered, let us turn attention for a moment to FIG. 3 which, effectively, illustrates in greater detail that which is shown in FIGS. 1 and 2. Included in the illustration presented in FIG. 3 are three diamond-shaped blocks 30, 32, 34, and twelve rectangular blocks 36-58 (even numbers only), inclusive. A comparative viewing of FIGS. 1, 2 and 3 will make readily apparent to those skilled in the art how the components shown in FIG. 3 relate to those which are pictured in FIGS. 1 and 2.

As illustrated in FIG. 3, block 36 represents the start of an implementation of the methodology of the invention, and block 30 represents, essentially, the same as that which is represented by block 12 in FIG. 1. If a user elects to use toner-save rendering, control passes to block 38, and if not, control passes to block 40. Block 38 effectively places the relevant imaging system in a condition ready for bi-tonal modal operation with respect to any implemented toner-save rendering. Next, blocks 42, 44, 46 (which combinedly are represented by single block 16 in FIG. 1), assess the category, among the three mentioned earlier, of color imagery which is to be rendered. If control, instead of being handed to block 38, goes to block 40, then conventional, regular rendering of a particular image takes place, and the rendered result is sent to block 58 which is the same, effectively, as block 22 in FIG. 1.

Diamond blocks 32, 34 are referred to herein as thresholding blocks, and represent the determinations which are performed, as earlier mentioned, with respect to assessing threshold characteristics of text and graphics images, respectively. The functionalities of these blocks are represented collectively in FIG. 1 within block 14. No such diamond-shape thresholding block is employed on the downstream side of block 46, inasmuch as the categorical determination that a raster image is to be rendered is all that needs to occur in order for toner-save rendering to be implemented for such an image.

With regard to a text image, if the threshold font size characteristic is appropriate, toner-save rendering is implemented in block 48, and the rendered result is passed to block 58. If the text font size threshold is not met, the image is passed for rendering in a regular fashion within block 50, and from this block, rendered data is passed to print block 58.

With respect to a graphics image, a “Yes” answer with respect to image characteristics related to pixel height and pixel width dimensions causes control to pass through block 52 for toner-save rendering, and thence to print block 58. If either the height or the width threshold level is not met by a particular reviewed graphics image, rendering is performed in a normal, non-toner-save manner within block 54, with the “normally” rendered image data then being passed to print block 58.

A raster image is simply automatically toner-save rendered as illustrated by block 56 in FIG. 3. This toner-save rendered raster image is then passed along to print block 58.

It should be apparent that blocks 40, 50 and 54 in FIG. 3 are represented by singular block 20 in FIG. 1. Similarly, it should be apparent that blocks 48, 52, 56 in FIG. 3 are represented by singular block 18 in FIG. 1. With respect to the activities which are effected by toner-save rendering blocks 48, 52, 56 in FIG. 3, these activities are implemented in blocks 26, 28 in FIG. 2.

Turning attention now to FIG. 4 in the drawings, illustrated in this figure, in a row-and-column fashion at 60, is a representative image which is has been toner-save rendered in accordance with practice of the present invention. Image 60 is employed herein to illustrate practice of the invention with respect to each of the three categories of PDL images mentioned earlier, namely, text images, graphics images, and raster images. It will be assumed for the purpose of this description that image 60, with respect to its representation of a text image, is characterized with a font size of at least 12. With respect to thinking of image 60 as relating to a graphic image, one can see that the image shown here in FIG. 4 has a pixel height of 8-pixels as well as a pixel width of 8-pixels. Thus, what is shown in FIG. 4 meets the minimum threshold requirements for the implementation of toner-save rendering for both text and graphics images. Thinking about image 60 as representing a raster image, that determination alone is sufficient to determine that toner-save rendering is appropriate.

Image 60, as mentioned above, is shown in a toner-save rendered condition. What will be noticed, therefore, about this thus-rendered image, is that edge density, shown generally at 62, has been preserved to form a continuous, bounding pixel edge 62. Within this preserved-density, bounding edge is a central pattern 64 which is checkerboarded in nature, and which very specifically, is checkerboarded in a manner which produces maximum pixel dot gain.

The invention thus proposes a unique, quite simply implemented, and very effective toner-save method which may be employed with regard to PDL text, graphics and raster color images, or objects. Where toner-save rendering is selected to be employed, once an image to be considered for toner-save rendering has been determined to pass all of the thresholding tests necessary, that image is toner-save rendered in a manner whereby pixel edge-region density is preserved, and central regions of the image are prepared with a maximized dot gain checkerboard pattern.

Accordingly, while a preferred embodiment and manner of practicing the invention have been described herein, it is appreciated that variations and modifications may be made therein without departing from the spirit of the invention, and it is intended that all claims to invention herein will cover such variations and modifications.

We claim:

1. A pre-printing toner-save method for selective, different-character Page Description Language (PDL) color-object rendering of different-category PDL color objects comprising
fundamentally basing a decision about whether or not to implement toner-save rendering upon (a) the nature of the determined category of such an object, and (b) the application of a selected object-threshold parameter.

2. The method of claim 1 with respect to which the categories of PDL color objects include (a) text, (b) graphics, and (c) raster.

3. The method of claim 2, wherein a decision to implement toner-save rendering results in toner-save implementation in a bi-tonal mode of operation.

4. The method of claim 1, wherein implemented toner-save rendering includes the steps of (a) preserving object-edge dot density, and (b) within an object's edge, establishing a checkerboard pattern of dots which maximizes dot gain.

5. A pre-printing toner-save method for Page Description Language (PDL) color-object rendering of a color object which lies in one of the categories including (a) a text object, (b) a graphics object, and (c) a raster object, said method comprising
receiving information regarding in which of categories (a), (b) and (c) an object to be rendered lies,
for each such category respecting a particular object, assessing whether the associated object possesses a certain pre-established, associated threshold characteristic which makes it a candidate for toner-save rendering,
with respect to an object which is determined to lie in one of the three (a), (b) and (c) categories, and which possesses such a threshold characteristic, applying object-category-specific toner-save rendering, and
with respect to any object not lying in any of the (a), (b) and (c) categories, or lying in one of these categories but not possessing the associated threshold characteristic, bypassing toner-save rendering.

6. The method of claim 5, wherein, with respect to a text-category object, the associated threshold characteristic involves font size.

7. The method of claim 5, wherein, with respect to a graphics-category object, the associated threshold characteristic involves both object width and object height features.

8. The method of claim 5, wherein, with respect to a raster-object-category object, that categorical determination constitutes the associated threshold characteristic.

9. The method of claim 6, wherein, with respect to a graphics-category object, the associated threshold characteristic involves both object width and object height features.

10. The method of claim 6, wherein, with respect to a raster-object-category object, that categorical determination constitutes the associated threshold characteristic.

11. The method of claim 7, wherein, with respect to a raster-object-category object, that categorical determination constitutes the associated threshold characteristic.

12. The method of claim 9, wherein, with respect to a raster-object-category object, that categorical determination constitutes the associated threshold characteristic.

13. The method of claim 5, wherein toner-save rendering for a text-category object involves the steps of (a) preserving object-edge dot density, and (b) within an object's edge, establishing a checkerboard pattern of dots which maximizes dot gain.

14. The method of claim 5, wherein toner-save rendering for a graphics-category object involves the steps of (a) preserving object-edge dot density, and (b) within an object's edge, establishing a checkerboard pattern of dots which maximizes dot gain.

15. The method of claim 5, wherein toner-save rendering for a raster-object-category object involves the steps of (a) preserving object-edge dot density, and (b) within an object's edge, establishing a checkerboard pattern of dots which maximizes dot gain.

16. The method of claim 5, wherein toner save rendering involves the steps of (a) preserving object-edge dot density, and (b) within an object's edge, establishing a checkerboard pattern of dots which maximizes dot gain.

17. A pre-printing toner-save method for Page Description Language (PDL) color-object rendering of a color object comprising
selecting a PDL object to be toner-save rendered,
distinguishing edge-boundary regions from other regions in the selected object, and
applying different, region-specific, toner-save rendering modalities to such distinguished regions.

18. The method of claim 17, wherein the step of applying different, region-specific rendering modalities includes (a) preserving pixel density in edge regions in the object, and (b) producing a pixel pattern in other regions which generates maximizes dot gain.

19. A pre-printing toner-save method for Page Description Language (PDL) color-object rendering of a color object comprising
applying in different regions of an object a combination of toner-save rendering modalities including both (a) a pixel edge density preservation modality, and (b) a checkerboarding, dot-gain maximizing modality.
